(19) United States
(12) Patent Application Publication
(10) Pub. No.: US 2009/0212735 A1
(43) Pub. Date: Aug. 27, 2009

(54) RECONFIGURABLE CHARGING CONTROL MODULE

(75) Inventors: Chen-Pang Kung, Taoyuan County (TW); Wei-Hsin Hou, Taipei City (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu (TW)

(21) Appl. No.: 12/390,192

(22) Filed: Feb. 20, 2009

(30) Foreign Application Priority Data
Feb. 21, 2008 (TW) 97106038

(51) Int. Cl. H01M 10/46; H04Q 5/22; H02J 7/00

(52) U.S. Cl. 320/101; 340/10.1; 320/107; 320/108

(57) ABSTRACT

The present invention provides a reconfigurable charging control module whose energy transmission state can be changed or adjusted according to the specifications of an energy storage device that is to receive energy. The energy transmission state can be changed or adjusted in a contact or contactless manner. In addition, the energy transmission state of the reconfigurable charging control module can be set in a contact or contactless manner in advance, and then incorporated with an energy storage device to form an energy storage system.

### BACKGROUND OF THE INVENTION

1. Field of the Invention

The present invention relates to a charging control module, and more particularly, to a reconfigurable charging control module.

2. Description of the Related Art

Portable electronic products are becoming almost indispensable to people's everyday life nowadays and in the future. However, as there are products of different systems, such as mobile phones, digital cameras, laptops, etc., batteries of various specifications are needed for use with these products. With respect to the various battery specifications, they may require different output voltages, different output currents or have different capacities. Thus, different charging devices are needed for these products to meet their charging requirements, which is basically inconvenient for users. U.S. Pat. No. 7,288,918 discloses a wireless battery charger whose charging circuit is not programmable; that is, the output specifications of the charger cannot be changed or adjusted according to the specifications of its energy storage device. As a result, the disclosed battery charger cannot be applied to energy storage devices of various specifications. U.S. Patent Application Pub. No. 20030231001 discloses a wireless charging apparatus that uses a solar cell or fuel cell as the power supply source while utilizing a wireless charger to charge a portable electric energy storage device. As far as the wireless charger of the charging apparatus is concerned, its output specifications cannot be changed or adjusted to meet the requirements and various specifications of energy storage devices, either.

### SUMMARY OF THE INVENTION

The present invention provides a reconfigurable charging control module whose energy transmission state can be changed or adjusted according to different specifications of energy storage devices in a contact or contactless manner. Thus, the module of the present invention can be used to provide energy for the energy storage devices of different specifications.

A reconfigurable charging control module of the present invention can receive energy in a contact or contactless manner.

The present invention further provides an energy storage system integrating an energy storage device with a reconfigurable charging control module, wherein prior to the integration, the energy transmission state of the module can be changed or adjusted according to the energy storage device.

An energy storage system of the present invention can receive energy in a contact or contactless manner.

A reconfigurable charging control module of the present invention is provided in accordance with the foregoing, the module comprising a stored energy output unit and a rated voltage selection unit. The stored energy output unit provides an energy storage device with output energy, and the rated voltage selection unit controls the output energy of the stored energy output unit according to a rated voltage of the energy storage device.

In one aspect, data associated with the rated voltage of the energy storage device can be transmitted to the rated voltage selection unit of the reconfigurable charging control module in a contact or contactless manner.

In another aspect, the reconfigurable charging control module further comprises an energy receiving module that can receive energy in a contact or contactless manner.

An energy storage system of the present invention is provided in accordance with the foregoing, the system comprising an energy storage device and a reconfigurable charging control module. The reconfigurable charging control module comprises a stored energy output unit and a rated voltage selection unit, wherein the stored energy output unit provides the energy storage device with output energy, and the rated voltage selection unit controls the output energy of the stored energy output unit according to the rated voltage of the energy storage device.

In one aspect, the energy transmission state of the reconfigurable charging control module of the energy storage system can be changed or adjusted in advance, in a contact or contactless manner, according to the energy storage device.

In another aspect, the energy storage system can receive energy in a contact or contactless manner.

The present invention also provides an energy transmission system comprising an energy transmission module and a voltage selection control module. The energy transmission module transmits energy to an energy receiving end wirelessly, and the voltage selection control module controls the transmission state of the energy transmission module according to the energy receiving end.

In one aspect, the energy transmission system may be an RFID (radio frequency identification) reader.

In another aspect, the energy transmission module of the energy transmission system may be an antenna module, and the voltage selection control module may include a data input interface.

The present invention still further provides a reconfigurable charging control system, the system comprising an energy transmission system, an energy receiving system and a stored energy output unit. The energy transmission system comprises a wireless energy transmission module and a voltage selection control module, wherein the voltage selection control module transmits data associated with the rated voltage of an energy storage device to the wireless energy transmission module, which combines the data associated with the rated voltage with an energy signal and transmits them. The energy receiving system comprises an energy receiving module and a rated voltage selection unit, wherein the energy receiving module includes a photovoltaic module and a wireless energy receiving module. The photovoltaic module converts ambient light into electrical energy. The energy receiving module receives the energy signal and the data associated with the rated voltage and transmits the data to the rated voltage selection unit, which thereby transmits a control signal. The stored energy output unit receives the energy signal from the energy receiving module and the control signal from the rated voltage selection unit, determines the energy output state according to the control signal, and thereby transmits energy to the energy storage device.

In one aspect, the photovoltaic module of the reconfigurable charging control system may be replaced by a piezoelectric module that converts deformation kinetic energy into electrical energy.

### BRIEF DESCRIPTION OF THE DRAWINGS

FIG. 1 is a block diagram showing an energy storage system according to the present invention.

FIG. 2 is a block diagram showing a reconfigurable charging control system incorporated with an energy storage device according to the present invention.

FIG. 3 is a block diagram showing an embodiment of a reconfigurable charging control system of the present invention.

### DETAILED DESCRIPTION OF THE PREFERRED EMBODIMENTS

The present invention provides a reconfigurable charging control module for providing an energy storage device with energy. The energy transmission state of the module can be changed or adjusted according to the specifications of energy storage devices in a contact or contactless manner. In other words, the energy transmission state of the reconfigurable charging control module of the present invention can be changed or adjusted in accordance with different specifications of various energy storage devices, so that the power output specifications can meet different requirements for those energy storage devices.

The reconfigurable charging control module of the present invention can be incorporated with an energy storage device to form an energy storage system. Moreover, the energy transmission state of the module can be changed or adjusted in advance according to the specifications of the energy storage device that is to be incorporated, so that the energy transmission can meet the requirements for the energy storage device.

A reconfigurable charging control module and an energy storage system of the present invention will now be described in detail with reference to the following preferred embodiments and accompanying drawings.

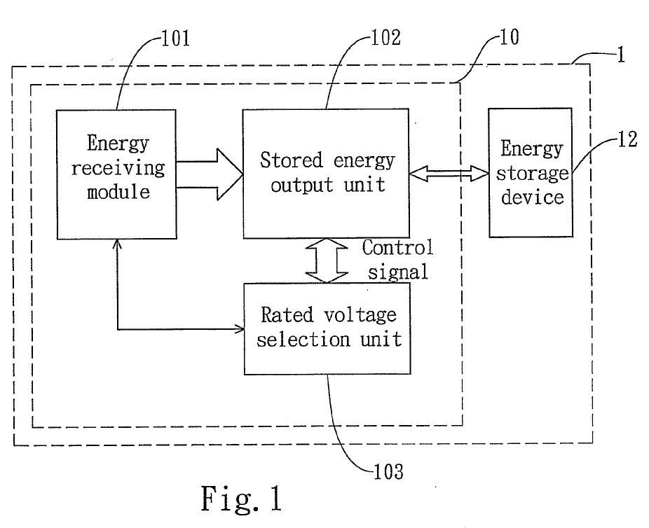

FIG. 1 is a block diagram showing a reconfigurable charging control module 10 and an energy storage system 1 according to the present invention. The reconfigurable charging control module 10 comprises an energy receiving module 101, a stored energy output unit 102 and a rated voltage selection unit 103. The energy receiving module 101 provides the stored energy output unit 102 with direct current energy. The energy receiving module 101 can receive energy in a contactless manner, such as by electromagnetic induction or photovoltaic conversion. Also, the energy receiving module 101 can receive energy in a contact manner. For example, a piezoelectric device that converts deformation kinetic energy into electrical energy may be used in an embodiment as the energy receiving module 101, or it may be an electrical contact attached to a power supply terminal to receive energy. In the embodiments where the energy receiving module 101 receives energy in a contactless manner, the module 101 may be an antenna module or a solar cell module. The stored energy output unit 102 is for outputting energy to an energy storage unit, such as the energy storage device 12. The rated voltage selection unit 103 transmits a control signal to the stored energy output unit 102 for controlling the amount of energy output from the stored energy output unit 102 to the energy storage device 12. More specifically, the rated voltage selection unit 103 transmits a control signal to the stored energy output unit 102 according to the specifications and requirements (such as output voltage, output current or capacity) of the energy storage device 12, so that the energy output state of the stored energy output unit 102 can be set. For example, the output state options may include “constant output current”, “constant output voltage” or “setting the output amount”. The rated voltage selection unit 103 can receive data associated with the rated voltage of energy storage device 12 in a contact or contactless manner. Then, based on the received data, the rated voltage selection unit 103 transmits the control signal to the stored energy output unit 102. The stored energy output unit 102 is capable of automatically detecting energy status and switching among its own output modes. Thus, after detecting the energy status (e.g. charging status) of the energy storage device 12, the stored energy output unit 102 can determine whether to change its energy output mode accordingly, from the constant output current mode to the constant output voltage mode for example. As a result, the stored energy output unit 102 can transmit energy to the energy storage device 12 effectively, while damage to the energy storage device 12 due to inadequate voltage or current supply is avoided.

The reconfigurable charging control module 10 of the present invention can have its energy transmission state changed or adjusted in accordance with the specifications of the energy storage unit that will be incorporated with the module. Therefore, the reconfigurable charging control module 10 can be used with different portable electronic products nowadays and meet their energy output requirements.

Referring to FIG. 1 again, the reconfigurable charging control module 10 is incorporated with the energy storage device 12 to form an energy storage system 1 of the present invention. Generally, the energy storage device 12 may be a rechargeable battery. The energy output state of the stored energy output unit 102, which is within the reconfigurable charging control module 10, can be set in advance to meet the specifications and requirements of the energy storage device 12. Then, the reconfigurable charging control module 10 can be integrated with the energy storage device 12 to form the energy storage system 1.

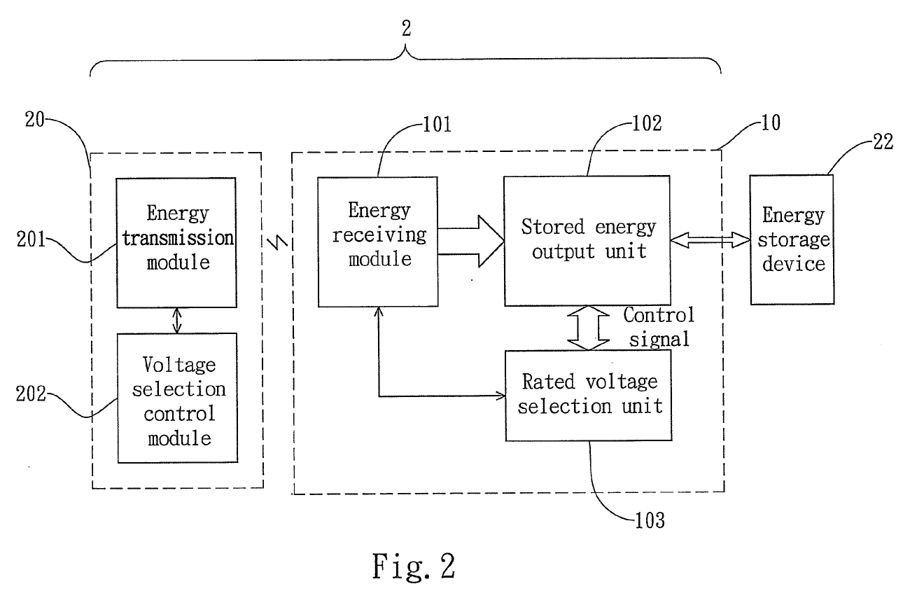

FIG. 2 shows a block diagram of a reconfigurable charging control system 2 of the present invention. The reconfigurable charging control system 2 is used for providing an energy storage device with energy, comprising a reconfigurable charging control module 10 as shown in FIG. 1 and an energy transmission system 20. The energy transmission system 20 includes an energy transmission module 201 and a voltage selection control module 202. The energy transmission system 20 can transmit energy/data to the reconfigurable charging control module 10 in a contactless manner such as wireless transmission. More specifically, the energy transmission module 201 can transmit energy to the energy receiving module 101 of the reconfigurable charging control module 10 in a contactless manner. In an embodiment, for example, the energy transmission module 201 and the energy receiving module 101 may be part of an antenna module that transmits/receives energy. The voltage selection control module 202 may include a data input interface, such as user interface, for the user to enter specifications data of the energy storage device 22 with a touch panel or keypad, so that the voltage selection control module 202 can use the specifications data for transmitting data associated with the rated voltage of energy storage device 22 to the rated voltage selection unit 103. The rated voltage selection unit 103 can thus set the energy transmission state of the stored energy output unit 102. The voltage selection control module 202 can transmit the data associated with the rated voltage of energy storage device 22 to the rated voltage selection unit 103 in a contactless manner. In one embodiment, the energy transmission system 20 may be an RFID reader; that is, the energy transmission module 201 and the voltage selection control module 202 are integrated within an RFID reader.

FIG. 2 is an example showing that a reconfigurable charging control system 2 of the present invention can transmit energy/data wirelessly; however, the energy/data transmission way of the reconfigurable charging control system 2 is not limited hereto. The reconfigurable charging control system 2 can also transmit energy/data in a contact manner. That is to say, the energy transmission module 201 may make electrical contact with the energy receiving module 101 for energy transmission; for example, an electrical plug and electrical socket may be used. The energy transmission module 201 may be a power supply terminal, and the energy receiving module 101 may be an electrical contact such as a metal contact. Also, the voltage selection control module 202 may make electrical contact with the rated voltage selection unit 103 to transmit data. Furthermore, the energy receiving module 101 may be a piezoelectric device that converts deformation kinetic energy into electrical energy, or a photovoltaic device (e.g. solar cell module) that converts ambient light into electrical energy. If so, then the energy transmission module 201 is not needed for the reconfigurable charging control system 2, and the voltage selection control module 202 may have the data transmitted by establishing electrical contact.

What follows will be a description of an embodiment where an RFID reader is used as the energy transmission system 20, so that the energy/data transmission operation of the reconfigurable charging control system 2 will be further explained. The reconfigurable charging control system 2 is first joined to the energy storage device 22. Next, the user enters the specifications data of the energy storage device 22 with a touch panel or keypad, and the data is sent to the voltage selection control module 202. Then, the voltage selection control module 202 transmits data associated with the rated voltage of the energy storage device 22 to the rated voltage selection unit 103. Based on the received data, the rated voltage selection unit 103 thereby transmits a control signal to the stored energy output unit 102 for setting its energy output state. At the same time, the voltage selection control module 202 transmits a signal to drive the energy transmission module 201, which transmits energy to the energy receiving module 101. The energy received by the energy receiving module 101 is then stored to the stored energy output unit 102 before the stored energy is plenty enough to be supplied to the energy storage device 22; the energy supply will meet the specifications and requirements of the energy storage device 22. Next, the stored energy output unit 102 outputs energy to the energy storage device 22 in accordance with the energy output state that is previously set. The stored energy output unit 102 also detects the energy status of the energy storage device 22 automatically to determine whether to change the present energy output mode or not. If yes, the stored energy output unit 102 will switch to another energy output mode automatically.

The reconfigurable charging control system 2 of the present invention can be used with energy storage devices of different specifications, and the energy output state of the stored energy output unit 102 can be changed or adjusted to meet the specifications of the energy storage device 22.

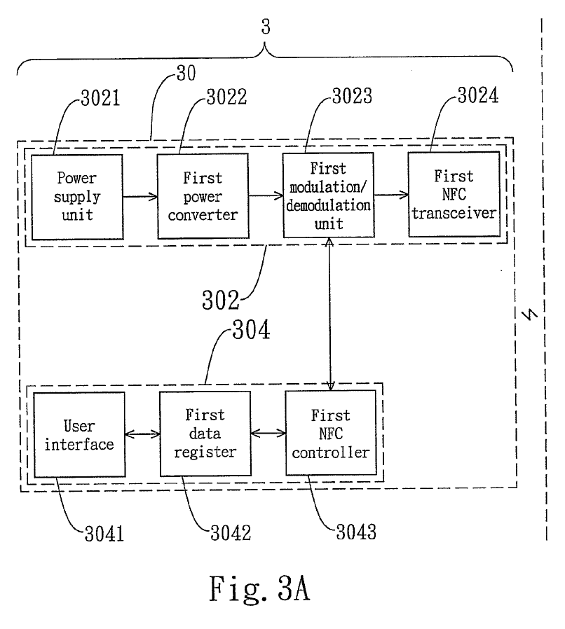

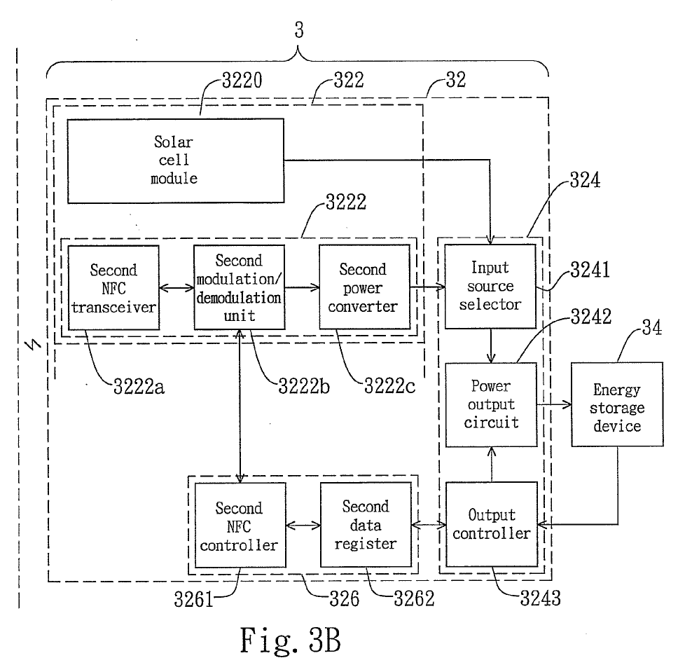

FIG. 3 shows a block diagram of a reconfigurable charging control system 3, which is incorporated with an energy storage device 34 such as power storage device for an electronic product, according to an embodiment of the present invention. The reconfigurable charging control system 3 comprises an energy transmission system 30 and a reconfigurable charging control module 32. The energy transmission system 30 comprises an energy transmission module 302 and a voltage selection control module 304. The energy transmission module 302 comprises a power supply unit 3021, a first power converter 3022, a first modulation/demodulation unit 3023 and a first NFC (near field communication) transceiver 3024, wherein the power supply unit 3021 may be a built-in fuel battery, solar cell battery or an external AC power supply terminal. The voltage selection control module 304 comprises a user interface 3041, a first data register 3042 and a first NFC controller 3043. The reconfigurable charging control module 32 comprises an energy receiving module 322, a stored energy output unit 324 and a rated voltage selection unit 326. The energy receiving module 322 comprises a solar cell module 3220 and a wireless energy receiving module 3222 having a second NFC controller 3222a, a second modulation/demodulation unit 3222b and a second power converter 3222c, and the solar cell module 3220 may be replaced by a photovoltaic module or a piezoelectric module. The stored energy output unit 324 comprises an input source selector 3241, a power output circuit 3242 and an output controller 3243. The rated voltage selection unit 326 comprises a second NFC controller 3261 and a second data register 3262. Detailed description of how the reconfigurable charging control system 3 provides energy for the energy storage device 34 is given below.

First, the user may use a touch panel or a keypad to enter the specifications data of the energy storage device 34 into the voltage selection control module 304 through the user interface 3041, and the specifications data are stored to the first data register 3042. The first NFC controller 3043 then accesses the specifications data stored in the first data register 3042, transmitting them to the first modulation/demodulation unit 3023 of the energy transmission module 302. The first modulation/demodulation unit 3023 converts the specifications data of the energy storage device 34 into the data associated with the rated voltage of the energy storage device 34. The power supply unit 3021 of the energy transmission module 302 provides a direct current or an alternating current, or a direct voltage or alternating voltage to the first power converter 3022 to convert to an energy signal that meets the specifications of the first NFC transceiver 3024, and then sending to the first modulation/demodulation unit 3023. The first modulation/demodulation unit 3023 combines the energy signal and the data associated with the rated voltage of the energy storage device 34, and sending them to the first NFC transceiver 3024 for transmission. The second NFC transceiver 3222a of the energy receiving module 322 of the reconfigurable charging control module 32 receives the energy signal and the data associated with the rated voltage of the energy storage device 34, and sending them to the second modulation/demodulation unit 3222b. The second modulation/demodulation unit 3222b sends the received data associated with the rated voltage of the energy storage device 34 to the second NFC controller 3261 of the rated voltage selection unit 326 and sends the received energy signal to the second power converter 3222c. The second power converter 3222c converts the energy signal to an electrical energy signal that meets the operation specifications of the stored energy output unit 324. The second NFC controller 3261 stores the received data associated with the rated voltage of the energy storage device 34 in the second data register 3262. The second data register 3262 sends a control signal to the stored energy output unit 324 according to the data associated with the rated voltage of the energy storage device 34.

The built-in solar cell module 3220 in the energy receiving module 322 receives ambient light and transmits it into electrical energy. The solar cell module 3220 has a built-in power converter (not shown) for converting the electrical energy stored in the module 3220 into electrical energy signals that meet the specifications of the stored energy output unit 324. The input source selector 3241 of the stored energy output unit 324 receives electrical energy signals from the solar cell module 3220 as well as the second power converter 3222c of the wireless energy receiving module 3222. By determining whether the solar cell module 3220 or the wireless energy receiving module 3222 contains enough stored energy for the energy storage device 34, the input source selector 3241 then selects one of them to provide electrical energy for the stored energy output unit 324. Electrical energy provided by the energy receiving module 322 will be transmitted to the power output circuit 3242 via the input source selector 3241. On the other hand, the control signal transmitted by the second data register 3262 of the rated voltage selection unit 326 is received by the output controller 3243 of the stored energy output unit 324, which further transmits the control signal to the power output circuit 3242. Then, the power output circuit 3242 determines its energy output state according to the control signal; with the output state being set in accordance with the specifications and requirements of the energy storage device 34, the power output circuit 3242 begins to transmit electrical energy to the device 34. Moreover, the energy storage device 34 will transmit a feedback signal to the output controller 3243 of the stored energy output unit 324, and the feedback signal is further transmitted to the power output circuit 3242. The feedback signal is about the energy status of the energy storage device 34, so that the power output circuit 3242 can determine whether to switch to another energy output mode or not (for example, whether to switch from the constant output current mode to the constant output voltage mode). At the same time, the output controller 3243 transmits the feedback signal to the rated voltage selection unit 326. The feedback signal is then transmitted to the energy transmission module 302 via the wireless energy receiving module 3222 and further transmitted to the voltage selection control module 304, so that the energy status of the energy storage device 34 is displayed on the user interface 3041. A reconfigurable charging control module of the present invention can be incorporated with energy storage devices of different specifications, and then the energy transmission state of the module can be changed or adjusted according to the specifications of the energy storage device, so that energy will be properly stored to the energy storage device. A reconfigurable charging control module of the present invention can make it more convenient to use portable electronic products nowadays.

While the present invention has been described by way of examples and in terms of preferred embodiments, it is to be understood that this invention is not limited hereto, and that various changes, substitutions, and alterations can be made herein without departing from the spirit and scope of this invention as defined by the appended claims.

What is claimed is:

1. A reconfigurable charging control module, comprising:
a stored energy output unit for providing an energy storage device with output energy; and
a rated voltage selection unit for controlling said output energy of said stored energy output unit according to a rated voltage of said energy storage device.

2. The reconfigurable charging control module of claim 1, further comprising an energy receiving module for providing said stored energy output unit with electrical energy.

3. The reconfigurable charging control module of claim 2, further comprising an energy transmission module for providing said energy receiving module with energy.

4. The reconfigurable charging control module of claim 1, further comprising a voltage selection control module for transmitting data associated with the rated voltage of said energy storage device to said rated voltage selection unit, and thereby said rated voltage selection unit can control said output energy from said stored energy output unit.

5. The reconfigurable charging control module of claim 2, further comprising a voltage selection control module for transmitting data associated with the rated voltage of said energy storage device to said rated voltage selection unit, and thereby said rated voltage selection unit can control said output energy from said stored energy output unit.

6. The reconfigurable charging control module of claim 3, further comprising a voltage selection control module for transmitting data associated with the rated voltage of said energy storage device to said rated voltage selection unit, and thereby said rated voltage selection unit can control said output energy from said stored energy output unit.

7. The reconfigurable charging control module of claim 2, wherein said energy receiving module receives energy in a contact or contactless manner.

8. The reconfigurable charging control module of claim 7, wherein said energy receiving module includes an antenna module, a photovoltaic device, a piezoelectric device or an electrical contact.

9. The reconfigurable charging control module of claim 3, wherein said energy transmission module transmits energy in a contact or contactless manner.

10. The reconfigurable charging control module of claim 9, wherein said energy transmission module includes an RFID (radio frequency identification) reader or an antenna module.

11. The reconfigurable charging control module of claim 4, wherein said voltage selection control module transmits said data associated with the rated voltage of said energy storage device in a contact or contactless manner.

12. The reconfigurable charging control module of claim 6, wherein said energy transmission module and said voltage selection control module are integrated within an RFID reader.

13. An energy storage system, comprising:
an energy storage device; and
a reconfigurable charging control module comprising a stored energy output unit and a rated voltage selection unit, wherein said stored energy output unit provides said energy storage device with output energy, and said rated voltage selection unit controls said output energy of said stored energy output unit according to a rated voltage of said energy storage device.

14. The energy storage system of claim 13, wherein said reconfigurable charging control module further comprises an energy receiving module for providing said stored energy output unit with electrical energy.

15. The energy storage system of claim 14, further comprising an energy transmission module for providing said energy receiving module with energy.

16. The energy storage system of claim 13, further comprising a voltage selection control module for transmitting data associated with the rated voltage of said energy storage device to said rated voltage selection unit, and thereby said rated voltage selection unit can control said output energy from said stored energy output unit.

17. The energy storage system of claim 14, further comprising a voltage selection control module for transmitting data associated with the rated voltage of said energy storage device to said rated voltage selection unit, and thereby said rated voltage selection unit can control said output energy from said stored energy output unit.

18. The energy storage system of claim 15, further comprising a voltage selection control module for transmitting data associated with the rated voltage of said energy storage device to said rated voltage selection unit, and thereby said rated voltage selection unit can control said output energy from said stored energy output unit.

19. The energy storage system of claim 14, wherein said energy receiving module receives energy in a contact or contactless manner.

20. The energy storage system of claim 19, wherein said energy receiving module includes an antenna module, a photovoltaic device, a piezoelectric device or an electrical contact.

21. The energy storage system of claim 15, wherein said energy transmission module transmits energy in a contact or contactless manner.

22. The energy storage system of claim 21, wherein said energy transmission module includes an RFID reader or an antenna module.

23. The energy storage system of claim 16, wherein said voltage selection control module transmits said data associated with the rated voltage of said energy storage device in a contact or contactless manner.

24. The energy storage system of claim 18, wherein said energy transmission module and said voltage selection control module are integrated within an RFID reader.

25. The energy storage system of claim 13, wherein said energy storage device is a rechargeable battery.

26. An energy transmission system, comprising:
an energy transmission module for transmitting energy to an energy receiving end wirelessly; and
a voltage selection control module for controlling the transmission state of said energy transmission module according to said energy receiving end.

27. The energy transmission system of claim 26, wherein said energy transmission system is an RFID reader.

28. The energy transmission system of claim 26, wherein said energy transmission module is an antenna module.

29. The energy transmission system of claim 26, wherein said voltage selection control module includes a data input interface.

30. A reconfigurable charging control system, comprising:
an energy transmission system comprising a wireless energy transmission module and a voltage selection control module, wherein said voltage selection control module transmits data associated with a rated voltage of an energy storage device to said wireless energy transmission module, which combines said data associated with the rated voltage with an energy signal and transmits them;
an energy receiving system comprising an energy receiving module and a rated voltage selection unit, wherein said energy receiving module includes a photovoltaic module, a piezoelectric device and a wireless energy receiving module, said photovoltaic module and said piezoelectric device converting ambient light energy and deformation kinetic energy into electrical energy respectively, and said energy receiving module receives said energy signal and said data associated with the rated voltage and transmits said data to said rated voltage selection unit, which thereby transmits a control signal; and
a stored energy output unit for receiving said energy signal from said energy receiving module and said control signal from said rated voltage selection unit, determining the energy output state according to said control signal, and thereby transmitting energy to said energy storage device.

31. The reconfigurable charging control system of claim 30, wherein said energy transmission system includes a power supply unit selected from a fuel battery, a solar battery, a piezoelectric module or an AC power supply terminal.

32. The reconfigurable charging control system of claim 30, wherein said voltage selection control module includes a user interface for receiving specification data of said energy storage device, and said voltage selection control module converts said specification data into said data associated with the rated voltage.

33. The reconfigurable charging control system of claim 30, wherein said stored energy output unit selects a source for receiving an energy signal according to the energy status of said photovoltaic module, said piezoelectric device and said wireless energy receiving module.
